(19) United States
(12) Patent Application Publication
(10) Pub. No.: US 2015/0122754 A1
(43) Pub. Date: May 7, 2015

(54) COIN HOLDER FOR CASH REGISTER

(71) Applicant: Steven Leong Jung, Vancouver (CA)

(72) Inventor: Steven Leong Jung, Vancouver (CA)

(21) Appl. No.: 14/245,425

(22) Filed: Apr. 4, 2014

(30) Foreign Application Priority Data
Nov. 4, 2013 (CA) 2832457

(51) Int. Cl. G07D 9/00

(52) U.S. Cl. CPC G07D 9/002
USPC 211/49.1

(57) ABSTRACT

A coin holder is provided which has a base portion and at least one elongate trough defined in the base portion. Each trough is sized and shaped to receive a stack of a particular denomination of coins. A plurality of regularly-spaced grooves is formed in the bottom surface of at least one trough. The grooves are oriented transversely to the trough. Each one of the grooves is adapted to receive one of the coins in the stack. The grooves are spaced apart so that every nth coin in the stack is received in one of the grooves. The grooves are shaped so that every nth coin in the stack is laterally displaced from adjacent coins in a generally vertical direction to provide a discernible pattern in the stack of coins.

### TECHNICAL FIELD

The apparatus described herein relate to coin holders. Particular embodiments relate to apparatus for storing and counting coins.

### BACKGROUND

Cash register trays or drawers typically comprise a plurality of compartments. There are generally a number of compartments for holding banknotes and a number of other compartments for holding coins. The banknotes and coins can be organized in the tray so that each compartment contains banknotes or coins of the same denomination. During a cash transaction, banknotes or coins are placed into or taken from the compartments by the cash register operator.

Coins are generally put into the drawer to form a pile of coins in each compartment. When the cash register operator wants to provide change to a customer, he has to take out and count the desired number of coins from the appropriate compartments. In addition, when balancing the cash register the operator has to count the piles of coins in each compartment to determine the value of the money contained in the drawer. This can be a tedious task and can take about 15 to 20 minutes or more to complete.

There is a general desire for apparatus that address at least some of the aforementioned problems.

The foregoing examples of the related art and limitations related thereto are intended to be illustrative and not exclusive. Other limitations of the related art will become apparent to those of skill in the art upon a reading of the specification and a study of the drawings.

### SUMMARY

Particular aspects provide a coin holder that may be placed in a cash register drawer. The coin holder has a base portion and at least one elongate trough defined in the base portion. Each trough is sized and shaped to receive a stack of a particular denomination of coins. A plurality of regularly-spaced grooves is formed in the bottom surface of at least one of the troughs, extending transversely to the trough. The plurality of grooves is spaced apart so that every nth coin in the stack is received in one of the plurality of grooves, so as to be laterally displaced from adjacent coins in a generally vertical direction to provide a discernible pattern in the stack of coins.

In some embodiments, graduated markings are provided on a surface of the base portion adjacent to the coin holder's trough and extending along a length of the trough. Each marking is aligned with a corresponding groove in the trough. The markings may consist of a line, notch, or other marking useful to assist with ascertainment of the value of the coins stacked in the trough.

In some embodiments, each trough is sloped upwardly from a first end of the trough to a second end of the trough. The second end of the trough may have a depression shaped and sized for receiving a finger to facilitate lifting of the coins from the trough.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a perspective view of a coin holder according to one embodiment that may be inserted in a cash register drawer.

FIG. 2 is an enlarged view of a portion of the FIG. 1 coin holder.

FIG. 3 is a top view of the FIG. 1 coin holder.

FIG. 4 is a perspective view of a cash register drawer in which is inserted a plurality of coin holders in accordance with the embodiment of FIG. 1.

### DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

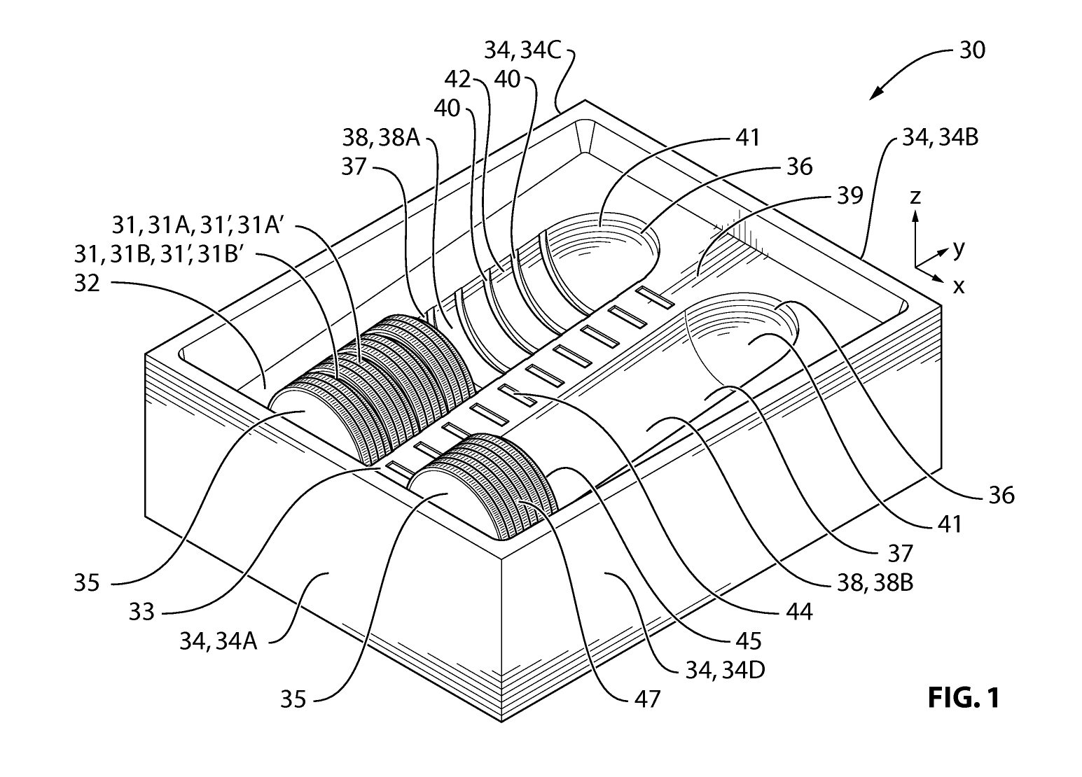

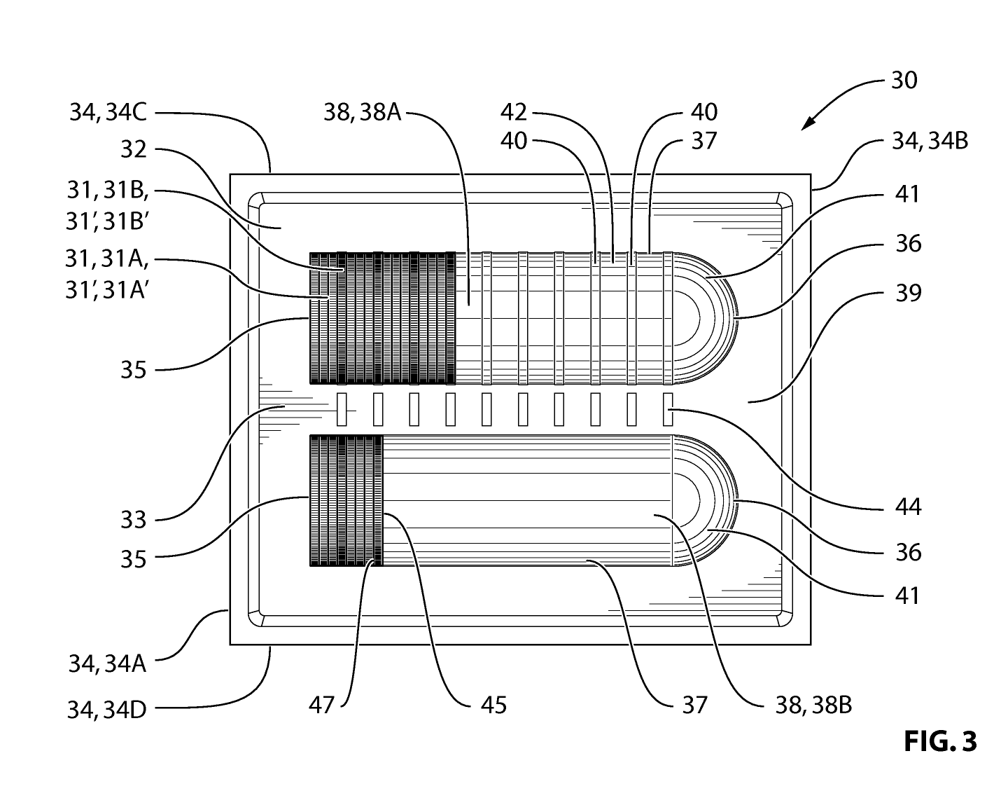

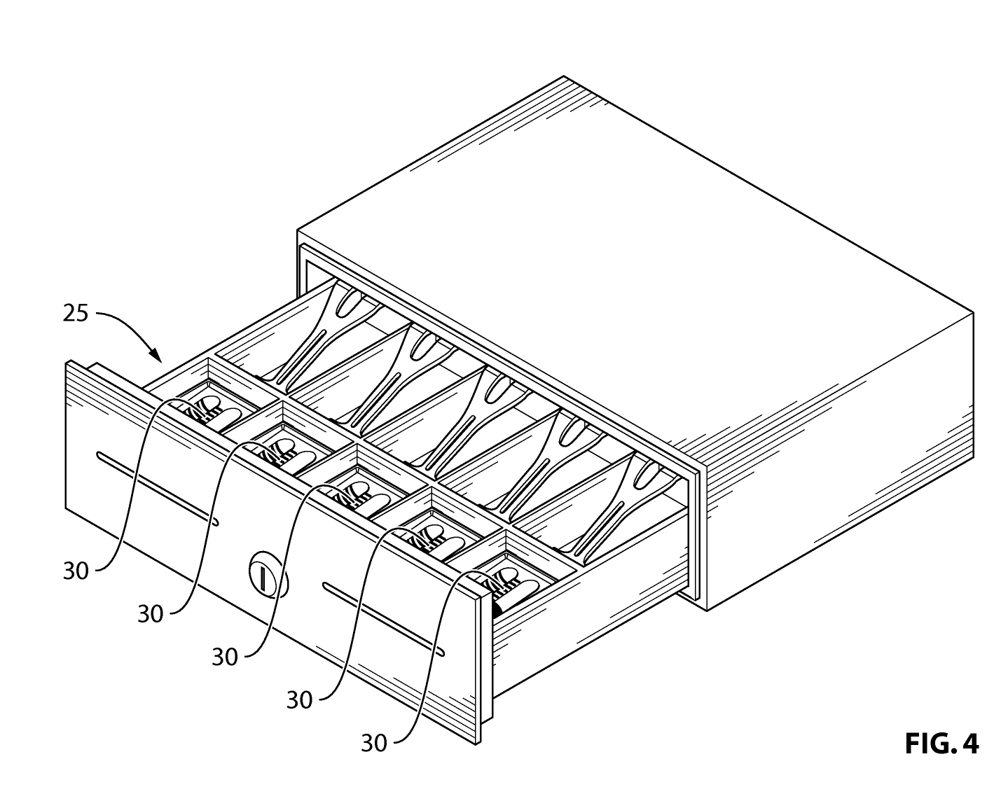

FIGS. 1, 2 and 3 illustrate a coin holder 30 according to one embodiment. Coin holder 30 may be inserted (in some cases along with one or more other similar coin holders 30 as shown in FIG. 4) into a cash register drawer for holding a plurality of coins 31. In the illustrated embodiment, as best seen in FIGS. 1 and 3, coin holder 30 has a generally rectangular base 32. Four walls 34 extend upwardly, in a generally vertical direction, from base 32. Walls 34 comprise a pair of opposing transversely-extending end walls 34A, 34B, and a pair of opposing longitudinally-extending side walls 34C, 34D extending between end walls 34A, 34B. Walls 34 together with base 32 define a general receptacle area 33 for holding coins 31. As used herein, “longitudinal” refers to a direction generally parallel to the y-axis shown in FIG. 1, “transverse” refers to a direction generally parallel to the x-axis shown in FIG. 1, and “vertical” refers to a direction generally parallel to the z-axis shown in FIG. 1.

One or more elongate troughs 38 are defined or provided in base 32 for holding coins 31. Troughs 38 may have a generally curved bottom surface 37 adapted to conform to a portion of a peripheral edge 47 of a circular (or generally circular) coin 31. Two troughs 38A, 38B are shown in FIG. 1. In the illustrated embodiment, troughs 38A, 38B are sized and shaped to hold quarters 31′ or coins with a $0.25 denomination. It is not necessary that there be two troughs 38. There may be any number of troughs 38 in base 32. In some embodiments coin holder 30 may have a plurality of troughs 38 each of which is sized and shaped to hold a different coin denomination, such as pennies, nickels, dimes, quarters, dollars (referred to in Canada as loonies), two dollars (referred to in Canada as toonies), etc. In other embodiments troughs 38 may be sized and shaped to hold other types of coin denominations in other kinds of currency.

Each trough 38 extends longitudinally between a first end 35 of trough 38 proximate to end wall 34A, and a second end 36 of trough 38 proximate to end wall 34B. Coins 31 are inserted oriented transversely in trough 38, such that the opposing planar surfaces 45 of each coin 31 are oriented perpendicularly to the length of trough 38. Coins 31 form a longitudinally-extending stack of coins in trough 38.

In certain embodiments, a set of troughs 38 may be provided for each denomination of coins wherein at least one of the troughs 38 in the set (trough(s) 38A in the illustrated embodiment) may be used for holding and counting the coins (e.g. for purposes of balancing the cash register drawer). The remaining troughs 38 in the set (trough(s) 38B in the illustrated embodiment) may be used to hold coins for purposes of facilitating cash transactions; during such transactions the cashier may take coins from and add coins to such trough 38B as needed. When it is time to count the coins, the coins in trough 38B may be transferred to trough 38A.

For example, at least one of troughs 38 may have transversely-extending grooves 40 to facilitate counting of coins. In the illustrated embodiment of FIG. 1, trough 38A has a plurality of grooves 40 defined in bottom surface 37, while the other trough 38B has a generally smooth (non-grooved) bottom surface 37. Each groove 40 in trough 38A is shaped to receive a single coin 31 of the particular denomination for which trough 38A is designed. Grooves 40 may be regularly spaced along the length of trough 38A. Spaces 42 in trough 38A between each pair of adjacent grooves 40 are also used for receiving coins 31.

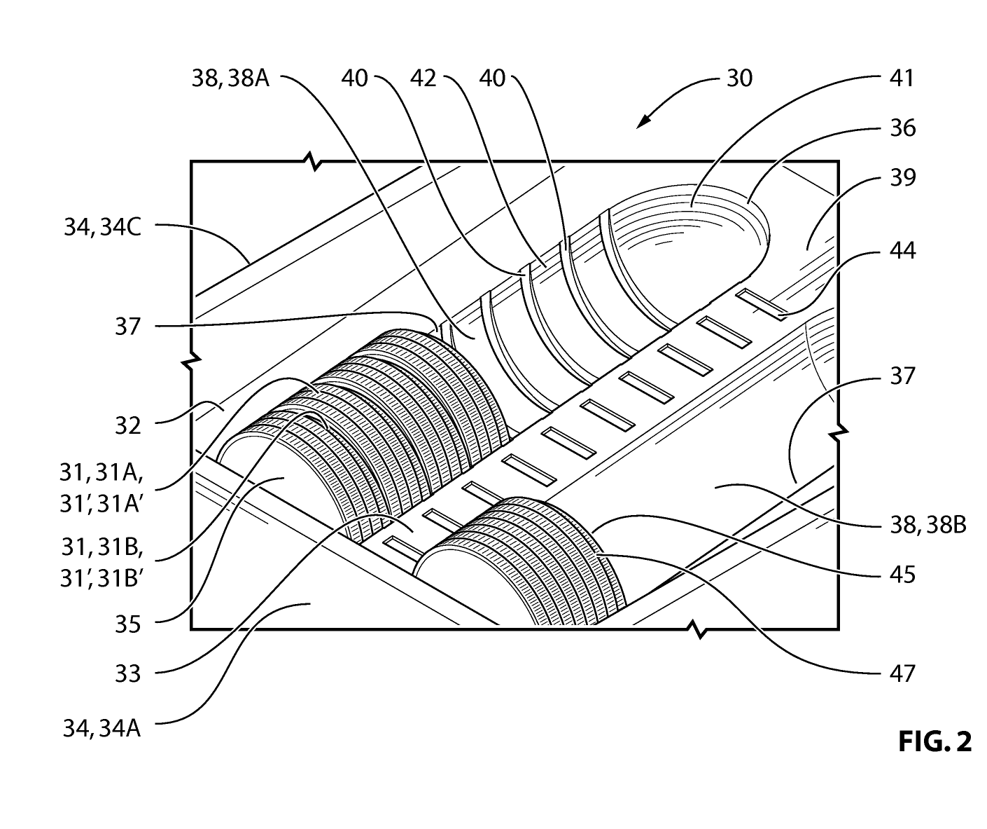

Grooves 40 are spaced apart so that when coins 31 are inserted in trough 38A, every nth coin 31B is received within a groove 40. The other coins 31A are stacked in the spaces 42 between each groove 40. Because of grooves 40, coins 31B are displaced relative to coins 31A in the vertical direction, such that each nth coin 31B sits in trough 38A at a lower position than the other coins 31A. As best seen in FIGS. 2 and 3, this arrangement of coins creates a discernible pattern that allows the operator to visually inspect and quickly ascertain the value of the coins in trough 38A without having to take out the coins to individually count them. This pattern is represented in FIG. 3 by the shading of coins 31A, 31B in trough 38A. The shading of each coin 31B in a groove 40 is darker than the shading of the remaining coins 31A, which are not received in a groove 40 but are instead held in the spaces 42 between each groove 40.

In the illustrated embodiment, troughs 38 of coin holder 30 are adapted to receive quarters 31′. To facilitate the counting of the coins in this embodiment, any quarters 31′ that are presently in trough 38B may be transferred to grooved trough 38A. Once all of the quarters 31′ are stacked in trough 38A, quarters 31′ may be grouped by way of grooves 40 into sets of four (i.e. n=4), since each set of four quarters conveniently has a value of $1. For example, in the illustrated embodiment the first, second and third quarters 31A′ are placed in a first space 42 proximate to the trough's first end 35. The fourth quarter 31B′ (i.e. the nth quarter) is placed in a first groove 40. This pattern is repeated for every n coins as the coins are inserted to fill trough 38A, starting from the trough's first end 35 and moving toward the trough's second end 36.

Other groupings may be used for other coin denominations. For example, it may be useful to group nickels into groups of five (i.e. n=5) since each set of five nickels has a value of $0.25. Similarly, it may be useful to group dimes into groups of five (i.e. n=5) since each set of five dimes has a value of $0.50. Grooves 40 may be spaced apart for the coin denomination for which the trough 38A is designed, so as to group the coins into sets of n coins (where every nth coin is received in a groove 40). The integer n may be selected for the denomination so that the value of n coins has a convenient amount for the purposes of adding up the value of the coins in trough 38A. In particular embodiments, n is either 4 or 5.

To further aid in ascertaining the value of the coins in trough 38A, the illustrated embodiment incorporates coin markings 44 provided along a longitudinally extending surface 39 of coin holder 30 that is adjacent to trough 38A. As best seen in FIG. 2, coin markings 44 comprise transversely-extending grooves, aligned with grooves 40 where each nth coin 31B would be received. It can be seen in the case illustrated in FIG. 2 that quarters 31′ placed into trough 38A happen to extend up to the fourth coin marking 44. Therefore it can be quickly determined by visual inspection in that case that in trough 38A there are four sets of n quarters 31′ (where n=4), or $4.00 of quarters 31′ in total. In the illustrated embodiment, coin markings 44 are also adjacent trough 38B, and so they also may be used to help ascertain the value of coins in trough 38B.

In other embodiments, coin markings 44 may comprise lines, protrusions, strips, apertures, variations in the texture in surface 39, or any other suitable marking that is useful to provide a visual or tactile guide to the cash register operator for purposes of ascertaining the value of coins in trough 38A.

In the illustrated embodiment of FIGS. 1 to 3, each trough 38's second end 36 extends toward second wall 34B, and is shaped so as to provide a rounded depression 41. Depression 41 may be useful to facilitate removal of coins 31 from trough 38. Depression 41 allows for the finger(s) of an operator to be inserted in trough 38 to lift the coins 31 from the trough. Depression 41 may be sized and shaped so that coins 31 are unable to fit within the depression, thereby reserving a space for the finger to be inserted.

To facilitate insertion and stacking of coins, trough 38 may be on an incline. For example, in the illustrated embodiment, trough 38 slopes downwardly from trough 38′s second end 36 toward trough 38's first end 35. Because of this slope, as they are inserted coins 31 will tend to slide down the trough 38 toward first end 35, so that coins 31 are stacked against first end 35. The slope may be on the order of 1° to 3° in some embodiments, in the order of 5° in other embodiments, and in the order of 10° to 15° in still other embodiments.

Coin holder 30 may be made of one or more of a number of different materials, including, for example, plastic, metal and/or wood. In particular embodiments coin holder 30 is molded from plastic and the troughs 38 have a smooth surface to facilitate insertion and stacking of coins 31.

As seen in FIG. 4, one or more coin holders 30 in accordance with embodiments described herein can be inserted into a cash register drawer 25 (or formed or otherwise provided in cash register drawer 25). The coin holders advantageously serve more than one purpose: in addition to storing the coins (organized by denomination), the coin holders also facilitate counting of the coins. For example the cash register operator may need to count the coins when making change for a customer, or when balancing the register at the end of a shift. The counting of coins is facilitated by the regularly-spaced grooves in the grooved troughs, which receive every nth coin in the stack of coins placed in the trough to create a visual pattern that allows the total value of the coins to be quickly determined simply by glancing at the stack of coins in the trough. In addition, the graduated markings alongside the trough assist with the determination of the total value of the coins. Thus, with the coin holders in the embodiments described herein, one does not need to take out all of the coins from the compartment and count them individually as for conventional cash register drawers. It can be appreciated that coin holders in accordance with embodiments described herein make it substantially more efficient to balance a cash register drawer, by eliminating the tedious steps required to count a pile of coins in a cash register drawer compartment. The coin holders significantly reduce the time required for the cash register operator to close a shift, thereby freeing up time for other duties.

In some embodiments, all troughs 38 in a coin holder 30 may incorporate grooves 40 to assist with counting of coins (i.e. unlike the illustrated embodiment of FIG. 1, where only one of the troughs—trough 38A—is grooved).

In the embodiments described above, grooves 40 create a discernible pattern in the arrangement of coins in grooved trough 38A, so as to permit ascertainment of the value of the coins without requiring the coins to be individually counted. In other embodiments, grooves 40 may be replaced with ridges, so that each nth coin 31B sits in trough 38 laterally displaced at a higher position relative to other coins 31A.

Where a component (e.g. trough, receptacle, base, wall, compartment, tray, drawer, groove, depression, marking, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which perform the function in the illustrated exemplary embodiments.

While a number of exemplary aspects and embodiments have been discussed above, those of skill in the art will recognize certain modifications, permutations, additions and sub-combinations thereof. It is therefore intended that the scope of the following appended claims and claims hereafter introduced should not be limited by the embodiments set forth in the examples, but should be given the broadest interpretation consistent with the description as a whole.

What is claimed is:

1. A coin holder comprising:
a base portion;
an elongate trough defined in the base portion, the trough sized and shaped to receive a stack of a particular denomination of coins; and
a plurality of regularly-spaced grooves formed in the bottom surface of the trough and extending transversely to the trough, wherein each one of the plurality of grooves is adapted to receive one of the coins in the stack and the plurality of grooves is spaced apart so that every nth coin in the stack is received in one of the plurality of grooves.

2. A coin holder according to claim 1, wherein the plurality of grooves is shaped so that every nth coin in the stack is laterally displaced from adjacent coins in a generally vertical direction to provide a discernible pattern in the stack of coins.

3. A coin holder according to claim 2, wherein n is a non-zero integer selected from the group of integers consisting of: 4, 5, 8 and 10.

4. A coin holder according to claim 2, comprising a plurality of graduated markings provided on a surface of the base portion adjacent to the trough and extending along a length of the trough.

5. A coin holder according to claim 4, wherein each one of the plurality of graduated markings is aligned with a corresponding one of the plurality of grooves in the trough.

6. A coin holder according to claim 5, wherein each one of the graduated markings comprises a line.

7. A coin holder according to claim 5, wherein each one of the graduated markings comprises a notch.

8. A coin holder according to claim 1, wherein the trough is sloped upwardly from a first end of the trough to a second end of the trough.

9. A coin holder according to claim 8, wherein a slope of the trough is between 5° and 15°.

10. A coin holder according to claim 8, wherein the second end of the trough comprises a depression shaped and sized for receiving a finger to facilitate lifting of the coins from the trough.

11. A coin holder according to claim 1, wherein the denomination of coins is selected from one of the following denominations:
penny;
nickel;
dime;
quarter; and
one dollar coin.

12. A coin holder according to claim 1, comprising one or more additional elongate troughs defined in the base portion, wherein each one of the one or more additional elongate troughs is sized and shaped to receive a stack of coins.

13. A coin holder according to claim 12 wherein the one or more additional elongate troughs have smooth bottom surfaces without grooves.

14. A coin holder according to claim 1, wherein the coin holder is molded from plastic.

15. A coin holder according to claim 1, comprising:
a pair of opposed transversely-extending end walls extending from the base portion; and
a pair of opposed longitudinally-extending side walls extending from the base portion, the side walls arranged generally perpendicularly to the end walls.

16. A cash register drawer comprising one or more coin holders in accordance with claim 1.

17. A coin holder comprising:
a base portion;
an elongate trough defined in the base portion, the trough sized and shaped to receive a stack of a particular denomination of coins; and
a plurality of regularly-spaced ridges formed in the bottom surface of the trough and extending transversely to the trough, wherein the plurality of ridges is spaced apart so that every nth coin in the stack is supported on one of the plurality of ridges.

18. A coin holder according to claim 17, wherein every nth coin in the stack is laterally displaced from adjacent coins in a generally vertical direction to provide a discernible pattern in the stack of coins.

19. A coin holder according to claim 18, wherein n is a non-zero integer selected from the group of integers consisting of: 4, 5, 8 and 10.

20. A coin holder according to claim 18, comprising a plurality of graduated markings provided on a surface of the base portion adjacent to the trough and extending along a length of the trough.

21. A coin holder according to claim 20, wherein each one of the plurality of graduated markings is aligned with a corresponding one of the plurality of ridges in the trough.
